(19) United States
(12) Patent Application Publication
(10) Pub. No.: US 2026/0360679 A1
(43) Pub. Date: Nov. 12, 2026

(54) MASS SPECTROMETER

(71) Applicant: SHIMADZU CORPORATION, Kyoto-shi (JP)

(72) Inventors: Koichi KIMURA, Kyoto-shi (JP); Hiroki MIYASHIRO, Kyoto-shi (JP); Masaru NISHIGUCHI, Kyoto-shi (JP)

(73) Assignee: SHIMADZU CORPORATION, Kyoto-shi (JP)

(21) Appl. No.: 19/635,878

(22) Filed: Apr. 1, 2026

(30) Foreign Application Priority Data
May 7, 2025 (JP) 2025-077593

(51) Int. Cl. H01J 49/00; H01J 49/04; H01J 49/06

(52) U.S. Cl. CPC H01J 49/0095; H01J 49/0422; H01J 49/067; H01J 49/068

(57) ABSTRACT

A mass spectrometer (1) comprising: an ion source (201) for generating ions from a sample; a gas cell (232) that defines a gas accommodation space within an evacuated analysis chamber and has an ion inlet and an ion outlet; four or more aperture plates (2331-2336) provided at the ion inlet, each having an opening for introducing ions formed along an ion flight path; a mass separation unit (235) for separating ions discharged from the ion outlet according to a mass-to-charge ratio; and an ion detector (236) for detecting ions separated by the mass separation unit, wherein each opening of the four or more aperture plates is formed in a size such that the interior of the gas cell is maintained at a predetermined pressure.

### TECHNICAL FIELD

The present invention relates to a mass spectrometer.

### BACKGROUND ART

Mass spectrometers are used to identify or quantify substances contained in a sample. In a mass spectrometer, for example, MS/MS analysis is performed in which, among ions generated from substances in a sample, ions having a specific mass-to-charge ratio (precursor ions) are fragmented to generate fragment ions (product ions), and these are mass-separated and detected. In MS/MS analysis, a collision gas is supplied to a collision cell provided in an analysis chamber maintained at a high vacuum, and the precursor ions are fragmented by causing the precursor ions to collide with the collision gas within the collision cell to generate fragment ions. The collision cell is composed of, for example, a cylindrical member, and is provided with an opening for introducing ions and an opening for discharging ions on both end faces thereof (for example, Patent Document 1).

### PRIOR ART DOCUMENTS

### Patent Documents

[Patent Document 1] International Publication No. 2022/049744

### SUMMARY OF THE INVENTION

### Problems to be Solved by the Invention

Conventionally, the interior of the collision cell is maintained at a predetermined pressure by reducing the diameters of both openings formed in the collision cell to suppress the outflow of the collision gas. However, if the diameter of the introduction-side opening for introducing ions is small, the amount of ions introduced into the collision cell is small, resulting in a problem of poor measurement sensitivity.

Here, the problems of the conventional technology have been explained using a mass spectrometer that performs MS/MS analysis as an example. However, in an inductively coupled plasma mass spectrometer (ICP-MS) that ionizes atoms (elements) contained in a sample for mass analysis, there is a similar problem when: a collision gas is introduced into a collision cell to cause collisions with monatomic ions to be analyzed and polyatomic ions having the same mass-to-charge ratio as the monatomic ions, in order to cause the latter to collide with gas molecules more times to lower their kinetic energy further and select only the monatomic ions; or a reaction gas is introduced into a reaction cell to cause polyatomic ions having the same mass-to-charge ratio as the monatomic ions to be analyzed to react and generate ions with different mass-to-charge ratios.

A problem to be solved by the present invention is to provide a mass spectrometer capable of improving measurement sensitivity while maintaining a predetermined pressure inside a cell provided in a vacuum into which a gas for collision with or reaction with ions generated from a sample is introduced.

### Means for Solving the Problems

A mass spectrometer according to the present invention made to solve the above problems includes:
an ion source configured to generate ions from a substance contained in a sample; a gas cell that defines a gas accommodation space into which a predetermined type of gas is supplied within an evacuated analysis chamber, the gas cell having an ion inlet and an ion outlet;
four or more aperture plates provided at the ion inlet, each having an opening for introducing the ions formed along a flight path of the ions;
a mass separation unit configured to separate ions discharged from the ion outlet according to a mass-to-charge ratio; and an ion detector configured to detect the ions separated by the mass separation unit, wherein each opening of the four or more aperture plates is formed in a size such that the interior of the gas cell is maintained at a predetermined pressure.

The gas cell includes: a collision cell into which a collision gas for collision with precursor ions generated from a sample in a mass spectrometer that performs MS/MS analysis is introduced; a collision cell into which a collision gas for collision with monatomic ions and polyatomic ions generated from a sample in an ICP-MS is introduced; and a gas cell into which a reaction gas for reacting polyatomic ions in an ICP-MS is introduced.

### Effects of the Invention

The mass spectrometer according to the present invention defines a gas accommodation space into which a predetermined type of gas is supplied within an evacuated analysis chamber, and includes a gas cell having an ion inlet and an ion outlet, and four or more aperture plates provided at the ion inlet, each having an opening for introducing ions formed along a flight path of the ions. In these four or more aperture plates, the openings are formed in such a size that the interior of the gas cell would not be maintained at a predetermined pressure with only three or fewer aperture plates, but the interior of the gas cell is maintained at the predetermined pressure by arranging four or more aperture plates.

In conventional mass spectrometers, for example, one aperture plate having an opening was arranged at each of the ion-introduction side end and the ion-discharge side end of the gas cell. Therefore, in order to maintain the interior of the gas cell at a predetermined pressure, it was necessary to make the openings of the aperture plates small in diameter to suppress the outflow of gas from the gas cell. Consequently, there was a problem of poor measurement sensitivity because the amount of ions introduced into the gas cell was small due to the small openings through which the ions were introduced.

In contrast, in the mass spectrometer according to the present invention, by arranging four or more aperture plates each having an opening for introducing ions formed along the flight path of the ions, gas attempting to flow out from the gas cell to the analysis chamber is stagnated, thereby suppressing the outflow of the gas. Therefore, the interior of the gas cell can be maintained at a predetermined pressure even if aperture plates having larger openings than conventional ones are used. Since the openings for introducing ions have a larger diameter than conventional ones, more ions are introduced into the gas cell, and measurement sensitivity is improved.

### BRIEF DESCRIPTION OF THE DRAWINGS

FIG. 1 is a configuration diagram of the main parts of a triple quadrupole mass spectrometer, which is an embodiment of the mass spectrometer according to the present invention.

FIG. 2 is a diagram showing the configuration of a second ion lens group in the mass spectrometer of the present embodiment.

### DESCRIPTION OF EMBODIMENTS

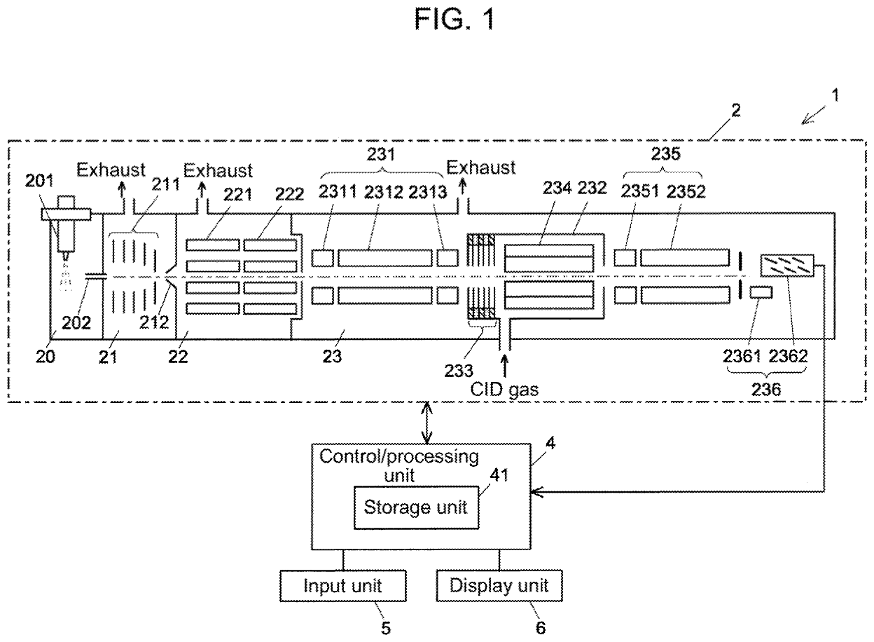

An embodiment of the mass spectrometer according to the present invention will be described below with reference to the drawings. FIG. 1 is a configuration diagram of the main parts of a triple quadrupole mass spectrometer (hereinafter also simply referred to as “mass spectrometer”) 1, which is an embodiment of the mass spectrometer according to the present invention.

The mass spectrometer 1 of the present embodiment is roughly composed of a mass analysis unit 2 and a control/processing unit 4 that controls the operation of each unit constituting the mass analysis unit 2.

The mass analysis unit 2 has an ionization chamber 20, a first intermediate vacuum chamber 21, a second intermediate vacuum chamber 22, and an analysis chamber 23. Each of these chambers is provided within a vacuum chamber. The ionization chamber 20 is at approximately atmospheric pressure, the first intermediate vacuum chamber 21 is a low vacuum chamber evacuated by a rotary pump (not shown), and the second intermediate vacuum chamber 22 and the analysis chamber 23 are high vacuum chambers evacuated by turbo molecular pumps. This constitutes a multi-stage differential pumping system in which the degree of vacuum increases stepwise in the order of the first intermediate vacuum chamber 21, the second intermediate vacuum chamber 22, and the analysis chamber 23.

The ionization chamber 20 is provided with an electrospray ionization probe (ESI probe) 201 that applies a charge to a sample solution and sprays it. The ionization chamber 20 and the first intermediate vacuum chamber 21 communicate with each other through a small-diameter capillary (desolvation tube) 202.

In the first intermediate vacuum chamber 21, a first ion lens group 211 composed of a plurality of annular electrodes (ion lenses) is arranged to transport ions to a subsequent stage while converging them. The first ion lens group 211 is arranged such that openings formed in each ion lens are aligned along an ion optical axis C, which is the central axis of the ion flight direction. The first intermediate vacuum chamber 21 and the second intermediate vacuum chamber 22 are separated by a skimmer 212 having a small hole at the top.

In the second intermediate vacuum chamber 22, a first ion guide 221 and a second ion guide 222, each composed of a plurality of rod electrodes, are arranged to transport ions to a subsequent stage while converging them. The second intermediate vacuum chamber 22 and the analysis chamber 23 communicate with each other through a small hole formed in a partition wall.

In the analysis chamber 23, a front-stage quadrupole mass filter (Q1) 231, a collision cell 232, a rear-stage quadrupole mass filter (Q3) 235, and an ion detector 236 are arranged. The collision cell 232 corresponds to the gas cell in the present invention. The front-stage quadrupole mass filter 231 is composed of a pre-rod electrode 2311, a main rod electrode 2312, and a post-rod electrode 2313.

The collision cell 232 has a cylindrical shape as a whole. A second ion lens group 233 is arranged at the inlet of the collision cell 232 (on the side of the ionization chamber 20), and a multipole ion guide (q2) 234 is arranged at a subsequent stage thereof. The second ion lens group 233 is composed of six annular electrodes (ion lenses) 2331 to 2336. The six electrodes 2331 to 2336 have the same shape and are arranged such that the opening portions of each ion lens are aligned along the ion optical axis C, which is the central axis of the ion flight direction. The second ion lens group 233 has a function of transporting ions to the subsequent stage while converging them, and a function of maintaining the pressure of the collision gas in the collision cell 232 constant. It is not essential in the present invention that the shapes of the six electrodes 2331 to 2336 are identical, but making them the same shape facilitates manufacturing, and the opening size becomes maximum when the conductance, which will be described later, is the same.

The multipole ion guide 234 is composed of eight plate-like electrodes. The eight plate-like electrodes are arranged so as to surround the ion optical axis C, and transport ions that have entered the collision cell 232 to the subsequent stage while converging them.

The collision cell 232 is provided with a gas introduction port for introducing a collision-induced dissociation gas (CID gas) such as argon gas or nitrogen gas. The rear-stage quadrupole mass filter 235 is composed of a pre-rod electrode 2351 and a main rod electrode 2352. The ion detector 236 includes a conversion dynode 2361 that receives ions to generate electrons, and a secondary electron multiplier 2362 that multiplies the electrons generated by the conversion dynode 2361.

The mass analysis unit 2 can perform SIM (Selected Ion Monitoring) measurement, MS/MS scan measurement (product ion scan measurement), MRM (Multiple Reaction Monitoring) measurement, and the like. In SIM measurement, the front-stage quadrupole mass filter (Q1) 231 does not select ions (does not function as a mass filter), and the mass-to-charge ratio of ions to be passed through the rear-stage quadrupole mass filter (Q3) 235 is fixed to detect ions.

On the other hand, in MS/MS scan measurement and MRM measurement, both the front-stage quadrupole mass filter (Q1) 231 and the rear-stage quadrupole mass filter (Q3) 235 are made to function as mass filters. The front-stage quadrupole mass filter (Q1) 231 passes only ions of a mass-to-charge ratio set as precursor ions. Further, CID gas is supplied to the interior of the collision cell 232 to dissociate the precursor ions and generate product ions. In MS/MS scan measurement, the mass-to-charge ratio of ions passing through the rear-stage quadrupole mass filter (Q3) 235 is scanned, and in MRM measurement, the mass-to-charge ratio of ions passing through the rear-stage quadrupole mass filter (Q3) 235 is fixed, to detect product ions.

The control/processing unit 4 includes a storage unit 41. The storage unit 41 stores information on voltages applied to each electrode during mass analysis of a sample, a database relating to various compounds, and the like. Further, the control/processing unit 4 has functions such as setting mass analysis conditions and performing mass analysis of a sample based on the set mass analysis conditions. The control/processing unit 4 is composed of, for example, a general personal computer, to which an input unit 5 composed of a keyboard, a mouse, and the like, and a display unit 6 composed of a liquid crystal display and the like are connected.

The mass spectrometer 1 of the present embodiment is characterized by the configuration of the collision cell 232, particularly the configuration of the second ion lens group 233.

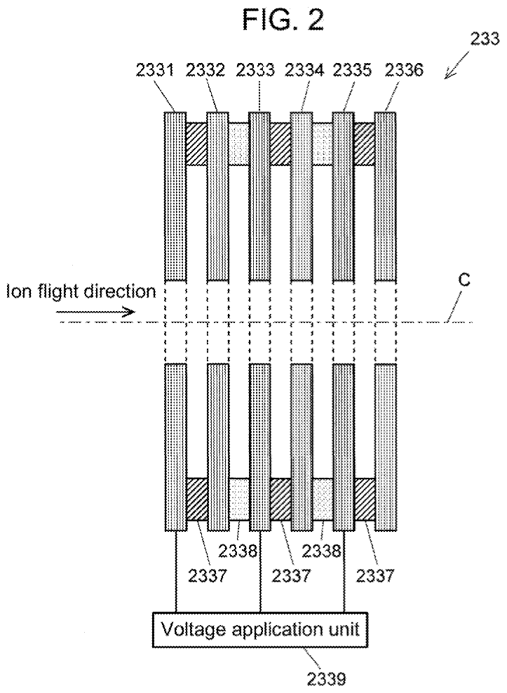

FIG. 2 shows the configuration of the second ion lens group 233. As described above, the second ion lens group 233 is composed of six annular electrodes (ion lenses) 2331 to 2336 having the same shape. These electrodes 2331 to 2336 function not only as ion lenses but also as members that separate the internal space of the collision cell 232 from the analysis chamber 23. The electrodes 2331 to 2336 correspond to the aperture plates in the present invention.

An annular spacer is arranged between adjacent electrodes. Taking two adjacent electrodes as one set, a conductive spacer 2337 (for example, a metal spacer) is arranged between electrodes belonging to the same set, and an insulating spacer 2338 (for example, a resin spacer) is arranged between electrodes belonging to different sets. As a result, the electrode 2331 and the electrode 2332 (first electrode set) connected by the conductive spacer 2337, the electrode 2333 and the electrode 2334 (second electrode set), and the electrode 2335 and the electrode 2336 (third electrode set) have the same potential. Although two electrodes constitute one set here, the number of electrodes constituting each set can be changed arbitrarily (it may be one). Further, the number of electrodes constituting each set may differ for each set.

Further, a DC voltage is applied to each of the electrode 2331, the electrode 2333, and the electrode 2335 from a voltage application unit 2339 under the control of the control/processing unit 4. In the present embodiment, a voltage is applied to each electrode such that an upward potential gradient is formed from the first electrode set toward the second electrode set, and a downward potential gradient is formed from the second electrode set toward the third electrode set. As a result, the ion group that has passed through the openings of the first electrode set is decelerated and compressed in the direction of the ion optical axis C in the process of moving toward the second electrode set, and the ion group that has passed through the openings of the second electrode set is accelerated in the process of moving toward the third electrode set. Consequently, variations in positions in the direction of the ion optical axis C, which were generated from the ionization chamber 20 until reaching the first electrode set, are reduced and the ion group is compressed, and subsequently, the compressed ion group is accelerated and enters the space surrounded by the multipole ion guide 234.

A collision gas (an inert gas such as argon) for causing precursor ions to collide is introduced into the collision cell 232 so as to reach a predetermined pressure (for example, 1 Pa) within the collision cell 232. On the other hand, the analysis chamber 23 where the collision cell 232 is arranged is evacuated to a high vacuum (for example, 10-3 Pa).

In conventional mass spectrometers, for example, the collision cell was defined within an evacuated analysis chamber by arranging one annular electrode each, having an opening for ion introduction/discharge, as an aperture plate at the inlet and the outlet of the collision cell. Therefore, in order to maintain the interior of the collision cell at a predetermined pressure, it was necessary to make the openings of the electrodes small in diameter to suppress the outflow of gas from the collision cell. However, there was a problem of poor measurement sensitivity because the openings through which ions were introduced were small and the amount of ions introduced into the collision cell was small.

In some conventional mass spectrometers, two or three annular electrodes are arranged as ion lenses at the ion inlet of the collision cell in order to converge ions entering the collision cell. For example, Patent Document 1 shows a configuration in which three annular electrodes are arranged at the ion inlet of a collision cell. When three annular electrodes are arranged at the ion inlet, it is possible to make the diameter of the openings serving as the ion inlet larger than when a single electrode is arranged, but even then, it is still difficult to obtain sufficient measurement sensitivity.

It is possible to increase the opening of the aperture plate if the flow rate of the collision gas supplied to the collision cell is increased and the displacement of the exhaust mechanism (vacuum pump) that exhausts the analysis chamber is increased. However, in that case, the consumption of the collision gas increases, and by increasing the size of the vacuum pump, the entire device also increases in size and cost increases.

The present inventor thought that if the conductance of the path connecting the collision cell 232 and the analysis chamber 23, i.e., the path through which the collision gas in the collision cell 232 flows out to the analysis chamber 23, can be maintained at a level similar to the conventional one, the diameter of the opening for introducing ions can be made larger in order to keep the pressure in the collision cell 232 constant, and arrived at the present invention. That is, the inventor thought that by arranging four or more electrodes, which is more than conventional, at the inlet of the collision cell 232, the diameter of the openings for introducing ions could be made larger than conventional ones.

Consider the conductance of the path (gas flow path) through which the collision gas flows when a space having a pressure difference is separated by a plurality of aperture plates each having an opening. The value of the conductance C of the gas flow path depends on the pressure difference between the collision cell 232 and the analysis chamber 23, the number of electrodes, and the diameter of the openings formed in the electrodes. Since the pressure difference between the collision cell 232 and the analysis chamber 23 is almost the same as the pressure inside the collision cell 232 (the aforementioned predetermined pressure), it can be approximated to the pressure inside the collision cell 232.

When six aperture plates as in the present embodiment are considered as six short cylinders (diameter D<length L) connected in series, the value of the conductance C can be estimated by the following formula (1).

$$[ Formula 1 ]$$

$$\frac{1}{C} = ( \frac{1}{{C}_{1}} + \frac{1}{{C}_{2}} + \frac{1}{{C}_{3}} + \frac{1}{{C}_{4}} + \frac{1}{{C}_{5}} + \frac{1}{{C}_{6}} ) \qquad ( 1 )$$

Here, C₁ to C₆ represent the conductance of each cylinder. Since the six aperture plates in the present embodiment are arranged in the analysis chamber 23, which is in a high vacuum, the gas flow can be considered as molecular flow (also called Knudsen flow; a flow in which gas molecules do not collide with each other but move while colliding almost only with the tube wall).

When the gas flow is molecular flow, the conductance Ci (i=1 to 6) of each cylinder is expressed by the following formula (2).

[Formula 2]

cᵢ=2.857(T/M)^{0.5}D²K (2)

Note that in the above formula, T is the temperature of the fluid (K), and M is the molar weight (molecular weight) (gr/mol). Further, K is expressed by the following formula (3).

[Formula 3]

K=1/{1+(3/4(L/D)} (3)

Using the above formula (2), the conductance of the gas flow path was obtained from a conventionally used mass spectrometer in which two annular electrodes each having an opening diameter D of Φ1.6 mm and a length L of 0.3 mm were arranged on the ion introduction side of the collision cell. Then, the size of the opening diameter capable of obtaining a conductance similar to the conventional one when six annular electrodes were arranged in the collision cell 232 was determined, and it was found that the opening diameter D was Φ2.7 mm (length L was 0.3 mm). Thus, in the mass spectrometer 1 of the present embodiment, by forming ion introduction openings having a diameter approximately 1.7 times larger than that of the conventional one, more ions can be introduced into the collision cell 232 to increase measurement sensitivity. In both the conventional mass spectrometer and the mass spectrometer of the present embodiment, the flow rate of the collision gas supplied to the collision cell 232 is 0.012-0.020 (L/min), and the pressure in the collision cell 232 (the predetermined pressure in the present invention) is 270-450 mPa.

Further, in the present embodiment, among the six electrodes, two adjacent electrodes are taken as one set and connected by a conductive spacer 2337, and an insulating spacer 2338 is arranged between different sets of electrodes. Therefore, these two electrodes can be brought to the same potential simply by applying a voltage to only one of the two electrodes belonging to the same set. Furthermore, since three sets of electrode pairs are arranged, the group of six electrodes can be made to function as an ion lens group, and the ion flight trajectory can be converged along the ion optical axis C, or by providing potential differences between the three sets of electrode pairs, the ion group can be compressed in the direction of the ion optical axis C into bunches, or the ion group can be accelerated/decelerated.

The above embodiment is an example and can be modified as appropriate according to the spirit of the present invention.

In the above embodiment, a triple quadrupole mass spectrometer was described. However, similar configurations can be adopted in other configurations of mass spectrometers equipped with a collision cell (such as a quadrupole-time-of-flight mass spectrometer). Further, although the collision cell for colliding precursor ions with collision gas was described in the above embodiment, a similar configuration can be adopted in a reaction cell used for reacting precursor ions with radicals.

Furthermore, in an inductively coupled plasma mass spectrometer (ICP-MS) that ionizes atoms (elements) contained in a sample for mass analysis, a similar configuration can be adopted when: a collision gas is introduced into a collision cell to cause collisions with monatomic ions to be analyzed and polyatomic ions having the same mass-to-charge ratio as the monatomic ions, in order to cause the latter to collide with gas molecules more times to lower their kinetic energy further and select only the monatomic ions; or a reaction gas is introduced into a gas cell to cause polyatomic ions having the same mass-to-charge ratio as the monatomic ions to be analyzed to react and generate ions with different mass-to-charge ratios.

In the above embodiment, six annular electrodes were used, but this number is an example, and any number of electrodes of four or more can be used. At this time, as the number of electrodes increases, the diameter of the openings for introducing ions can be made larger. However, even if the diameter of the opening is increased, if the ions passing through the opening do not pass through the space surrounded by the multipole ion guide 234 arranged in the collision cell 232, the ions will be lost within the collision cell 232 without being converged. Therefore, the upper limit of the diameter of the openings formed in the electrodes 2331 to 2336 should preferably be the size of the cross-section perpendicular to the ion optical axis C of the space surrounded by the multipole ion guide 234.

### [Aspects]

It is clear to those skilled in the art that the exemplary embodiments described above are specific examples of the following aspects.

### (Item 1)

A mass spectrometer according to one aspect of the present invention includes: an ion source configured to generate ions from a substance contained in a sample; a gas cell that defines a gas accommodation space into which a predetermined type of gas is supplied within an evacuated analysis chamber, the gas cell having an ion inlet and an ion outlet;
four or more aperture plates provided at the ion inlet, each having an opening for introducing the ions formed along a flight path of the ions;
a mass separation unit configured to separate ions discharged from the ion outlet according to a mass-to-charge ratio; and
an ion detector configured to detect the ions separated by the mass separation unit,
wherein each opening of the four or more aperture plates is formed in a size such that the interior of the gas cell is maintained at a predetermined pressure.

The gas cell includes: a collision cell into which a collision gas for collision with precursor ions generated from a sample in a mass spectrometer that performs MS/MS analysis is introduced; a collision cell into which a collision gas for collision with monatomic ions and polyatomic ions generated from a sample in an ICP-MS is introduced; and a gas cell into which a reaction gas for reacting polyatomic ions in an ICP-MS is introduced.

The mass spectrometer according to Item 1 defines a gas accommodation space into which a predetermined type of gas is supplied within an evacuated analysis chamber, and includes a gas cell having an ion inlet and an ion outlet, and four or more aperture plates provided at the ion inlet, each having an opening for introducing ions formed along a flight path of the ions. In these four or more aperture plates, the openings are formed in such a size that the interior of the gas cell would not be maintained at a predetermined pressure with only three or fewer aperture plates, but the interior of the gas cell is maintained at the predetermined pressure by arranging four or more aperture plates.

In conventional mass spectrometers, for example, one aperture plate having an opening was arranged at each of the ion-introduction side end and the ion-discharge side end of the gas cell. Therefore, in order to maintain the interior of the gas cell at a predetermined pressure, it was necessary to make the openings of the aperture plates small in diameter to suppress the outflow of gas from the gas cell. Consequently, there was a problem of poor measurement sensitivity because the amount of ions introduced into the gas cell was small due to the small openings through which the ions were introduced.

In contrast, in the mass spectrometer according to Item 1, by arranging four or more aperture plates each having an opening for introducing ions formed along the flight path of the ions, gas attempting to flow out from the gas cell to the analysis chamber is stagnated, thereby suppressing the outflow of the gas. Therefore, the interior of the gas cell can be maintained at a predetermined pressure even if aperture plates having larger openings than conventional ones are used. Since the openings for introducing ions have a larger diameter than conventional ones, more ions are introduced into the gas cell, and measurement sensitivity is improved.

### (Item 2)

The mass spectrometer according to Item 2 is the mass spectrometer according to Item 1, wherein
the aperture plates are each electrodes,
the four or more aperture plates are divided into a plurality of sets composed of one or more adjacent aperture plates, and the mass spectrometer further includes:
a conductive spacer configured to connect aperture plates belonging to a set composed of a plurality of aperture plates; and
a voltage application unit configured to apply a predetermined voltage to one of the aperture plates connected by the conductive spacer.

In the mass spectrometer according to Item 2, a plurality of aperture plates can be brought to the same potential simply by applying a voltage from the voltage application unit to one aperture plate (electrode) for each set.

### (Item 3)

The mass spectrometer according to Item 3 is the mass spectrometer according to Item 2, further including:
an insulating spacer configured to connect a plurality of aperture plates that are included in the four or more electrodes and located adjacent to each other, the aperture plates not being connected by the conductive spacer.

In the mass spectrometer according to Item 3, four or more aperture plates (electrodes) can be integrally configured.

### (Item 4)

The mass spectrometer according to Item 4 is the mass spectrometer according to either Item 2 or Item 3, wherein
the voltage application unit applies a voltage independently to aperture plates belonging to different sets.

In the mass spectrometer according to Item 4, a different voltage can be applied to each set.

### (Item 5)

The mass spectrometer according to Item 5 is the mass spectrometer according to any one of Items 1 to 4, further including:
an ion guide arranged inside the gas cell and composed of a plurality of electrodes arranged so as to surround a central axis of the ion flight path,
wherein a diameter of the opening is formed in a size equal to or smaller than a cross-section of a space surrounded by the ion guide perpendicular to the central axis.

In the mass spectrometer according to Item 1, the diameter of the openings for introducing ions can be increased as the number of apertures increases. However, even if the diameter of the aperture plate is increased, if the ions passing through the opening of the aperture plate do not enter the space surrounded by the ion guide, the ions are lost. In the mass spectrometer according to Item 5, such loss of ions can be prevented.

### DESCRIPTION OF REFERENCE NUMERALS

1 . . . Mass spectrometer
2 . . . Mass analysis unit
20 . . . Ionization chamber
202 . . . Capillary
21 . . . First intermediate vacuum chamber
211 . . . First ion lens group
212 . . . Skimmer
22 . . . Second intermediate vacuum chamber
221 . . . First ion guide
222 . . . Second ion guide
23 . . . Analysis chamber
231 . . . Front-stage quadrupole mass filter
2311 . . . Pre-rod electrode
2312 . . . Main rod electrode
2313 . . . Post-rod electrode
232 . . . Collision cell
233 . . . Second ion lens group
2331-2336 . . . Electrode (aperture plate)
2337 . . . Conductive spacer
2338 . . . Insulating spacer
2339 . . . Voltage application unit
234 . . . Multipole ion guide
235 . . . Rear-stage quadrupole mass filter
2351 . . . Pre-rod electrode
2352 . . . Main rod electrode
236 . . . Ion detector
2361 . . . Conversion dynode
2362 . . . Secondary electron multiplier
4 . . . Control/processing unit
41 . . . Storage unit
5 . . . Input unit
6 . . . Display unit

1. A mass spectrometer comprising:
an ion source configured to generate ions from a substance contained in a sample;
a gas cell that defines a gas accommodation space into which a predetermined type of gas is supplied within an evacuated analysis chamber, the gas cell having an ion inlet and an ion outlet;
four or more aperture plates provided at the ion inlet, each having an opening for introducing the ions formed along a flight path of the ions;
a mass separation unit configured to separate ions discharged from the ion outlet according to a mass-to-charge ratio; and
an ion detector configured to detect the ions separated by the mass separation unit,
wherein each opening of the four or more aperture plates is formed in a size such that the interior of the gas cell is maintained at a predetermined pressure.

2. The mass spectrometer according to claim 1, wherein
the aperture plates are each electrodes,
the four or more aperture plates are divided into a plurality of sets composed of one or more adjacent aperture plates, and the mass spectrometer further includes:
a conductive spacer configured to connect aperture plates belonging to a set composed of a plurality of aperture plates; and
a voltage application unit configured to apply a predetermined voltage to one of the aperture plates connected by the conductive spacer.

3. The mass spectrometer according to claim 2, further comprising:
an insulating spacer configured to connect a plurality of aperture plates that are included in the four or more electrodes and located adjacent to each other, the aperture plates not being connected by the conductive spacer.

4. The mass spectrometer according to claim 2, wherein the voltage application unit applies a voltage independently to aperture plates belonging to different sets.

5. The mass spectrometer according to claim 1, further comprising:
an ion guide arranged inside the gas cell and composed of a plurality of electrodes arranged so as to surround a central axis of the ion flight path,
wherein a diameter of the opening is formed in a size equal to or smaller than a cross-section of a space surrounded by the ion guide perpendicular to the central axis.
